(19) United States
(12) Patent Application Publication
(10) Pub. No.: US 2025/0348296 A1
(43) Pub. Date: Nov. 13, 2025

(54) METHOD AND SYSTEM FOR COMPILING NEURAL NETWORK, COMPUTER STORAGE MEDIUM, AND COMPILATION DEVICE

(71) Applicant: SHANGHAI JIAO TONG UNIVERSITY, Shanghai (CN)

(72) Inventors: Zihan LIU, Shanghai (CN); Jingwen LENG, Shanghai (CN); Guandong LU, Shanghai (CN); Quan CHEN, Shanghai (CN); Chao LI, Shanghai (CN); Minyi GUO, Shanghai (CN)

(73) Assignee: SHANGHAI JIAO TONG UNIVERSITY, (omitted)

(21) Appl. No.: 18/846,282

(22) PCT Filed: May 21, 2021
(86) PCT No.: PCT/CN2021/095209

§ 371 Date: Sep. 12, 2024

(30) Foreign Application Priority Data
Nov. 5, 2020 (CN) 202011224090.4

(51) Int. Cl. G06F 8/41

(52) U.S. Cl. CPC G06F 8/443

(57) ABSTRACT

A method and a system for compiling a neural network, a computer storage medium, and a compilation device are provided. The method for compiling the neural network comprises: translating a network file into an intermediate representation file; optimizing the intermediate representation file to obtain an optimized intermediate representation file, based on a performance analysis, single-node optimization, and collaborated optimization; generating a network template file based on hardware interfaces through the optimized intermediate representation file; compiling the network template file into an executable inference application. The present disclosure aims to design and implement an automated compilation toolchain framework. This framework adjusts parameters, generates code, creates intermediate representations (IRs), and applies optimization algorithms based on software and hardware information. When this compilation toolchain operates on a target chip, it ensures consistent network output results, achieves higher computation rates within shorter optimization times, reduces computation delays, and facilitates user debugging and tuning.

### FIELD OF THE INVENTION

The present disclosure belongs to the technical field of neural networks, and relates to a compilation method, in particular, to a method and a system for compiling a neural network, a computer storage medium, and a compilation device.

### BACKGROUND OF THE INVENTION

Recent advancements in neural networks have significantly propelled the fields of machine learning, artificial intelligence, and related industries. Applications such as facial recognition, speech recognition, online translation, and autonomous driving heavily rely on neural networks. However, the sheer size of neural network architectures and their computational demands pose challenges, particularly in terms of latency. Addressing this issue is crucial for widespread industrial adoption.

Current neural network compilation and optimization tools typically take user-provided network files and directly generate executable inference sessions for languages like Python and C++. During optimization, these tools apply predefined rules tailored to different target hardware and operators. This involves both front-end optimizations (such as operator fusion and common subexpression replacement) and back-end optimizations (hardware-specific techniques like loop unrolling and vectorization).

Despite their utility, these tools suffer from high encapsulation, limited user interfaces, and a lack of transparency into the optimization process and detailed algorithms, preventing users from further fine-tuning their work. Furthermore, their rigid optimization methods often miss out on significant opportunities in the front end, and their back-end optimizations lack portability across diverse hardware platforms, necessitating substantial human expert intervention.

To overcome these limitations, there is a pressing need for a method and a system for compiling a neural network, a computer storage medium, and a compilation device that overcome the shortcomings of traditional tools and provide improved user interfaces, visibility into optimization processes, flexibility in optimization algorithms, and better hardware portability. Solving these challenges will enhance the usability and effectiveness of deploying neural networks.

### SUMMARY OF THE INVENTION

In view of the above-mentioned shortcomings, the present disclosure provides a method and a system for compiling a neural network, a computer storage medium, and a compilation device, which allow for overcoming the shortcomings of traditional tools.

A first aspect of the present disclosure provides a method for compiling a neural network, comprising: translating a network file into an intermediate representation file; optimizing the intermediate representation file to obtain an optimized intermediate representation file, based on a performance analysis, single-node optimization, and collaborated optimization; generating a network template file based on hardware interfaces through the optimized intermediate representation file; compiling the network template file into an executable inference application.

In an embodiment of the present disclosure, the network file comprises a network structure and network parameters; the intermediate representation file comprises an abstraction layer, descriptions of the abstraction layer, and primary domains of the abstraction layer; the abstraction layer comprises a model, an operator set, fusion blocks, basic layers, and operational operators; a description of the model comprises describing a complete model execution flow; a description of the operator set comprises specifying an operator set version; a description of the fusion blocks comprises comprising a block fused from basic layers; a description of the basic layers comprises representing one of the operational operators in the network file; a description of the operational operators comprises providing a detailed description of the operational operators; primary domains of the model comprise a set of fusion blocks, and their intermediate representation; primary domains of the operator set comprise its version and a list of included operators; primary domains of the fusion blocks comprise a set of layers, and inputs and outputs of the layers; primary domains of the basic layers comprise operational operators, inputs, outputs, and model parallelisms; primary domains of the operational operators comprise operator types and operator attributes.

In an embodiment of the present disclosure, the optimizing of the intermediate representation file based on the performance analysis comprises: portraying the performance of the operational operators through performance tests, generating a series of measured performances with varying parameters, obtaining influence parameters affecting the performance of the operational operators, and constructing a mathematical model by the influence parameters to portray the performance of the operational operators.

In an embodiment of the present disclosure, the optimizing of the intermediate representation file based on the single-node optimization comprises: portraying the model parallelisms and operator fusion, selecting an optimal model parallelism for the operational operators, and portraying dimensions of fusion blocks, redundant computational amounts, and performance variation.

In an embodiment of the present disclosure, the optimizing of the intermediate representation file based on the collaborated optimization comprises: S21: reading a next basic layer; S22: determining whether this next basic layer is capable of being fused with a current fusion block; if capable, then performing S23: determining whether this next basic layer is a fully connected layer or a convolutional layer of the neural network; if yes, performing S24: counting a computational amount of this next basic layer and adding it to a current total computational amount, and performing S25: adding this next basic layer to the current fusion block, and proceeding to S27; if no, directly performing S25: adding this next basic layer to the current fusion block and proceeding to S27; if not capable, performing S26: opening a new fusion block; S27: determining whether the current total computational amount of fusion blocks exceeds a computation threshold, if yes, proceeding to S26; if no, returning to S21.

In an embodiment of the present disclosure, the generating of the network template file further comprises hiding redundant operations and exposing nodes to be optimized, by the abstraction layer.

In an embodiment of the present disclosure, the network template file is compiled into the executable inference application by a G++ compiler.

A second aspect of the present disclosure provides a system for compiling a neural network, comprising: a translation module configured to translate a network file into an intermediate representation file; an optimization module configured to optimize the intermediate representation file to obtain an optimized intermediate representation file, based on a performance analysis, single-node optimization, and collaborated optimization; a file generation module configured to generate a network template file based on hardware interfaces through the optimized intermediate representation file; and a compilation module configured to compile the network template file into an executable inference application.

A third aspect of the present disclosure provides a non-transitory computer-readable storage medium, configured to store a computer program, wherein a method for compiling the neural network according to any one of embodiments in the first aspect of the present disclosure is implemented when the computer program is executed by a processor.

A fourth aspect of the present disclosure provides a compilation device, comprising a processor and a memory; wherein the memory is configured to store a computer program, and the processor is configured to execute the computer program stored in the memory, such that the compilation device implements a method for compiling the neural network according to any one of embodiments in the first aspect of the present disclosure.

As described above, the method and system for compiling the neural network, the computer storage medium, and the compilation device have the following beneficial effects.

The method and system for compiling the neural network, the computer storage medium, and the compilation device of the present disclosure aim to design and implement an automated compilation toolchain framework. This framework adjusts parameters, generates code, creates intermediate representations (IRs), and applies optimization algorithms based on software and hardware information. When this compilation toolchain operates on a target chip, it ensures consistent network output results, achieves higher computation rates within shorter optimization times, reduces computation delays, and facilitates user debugging and tuning.

### BRIEF DESCRIPTION OF DRAWINGS

FIG. 1 shows a flowchart of a method for compiling a neural network according to an embodiment of the present disclosure.

FIG. 2 shows a flowchart illustrating an optimization of an intermediate representation file based on a collaborated optimization according to an embodiment of the present disclosure.

FIG. 3 shows a schematic diagram of a method for compiling a neural network according to an embodiment of the present disclosure.

### REFERENCE NUMERALS

3 System for compiling a neural network
31 Translation module
32 Optimization module
33 File generation module
34 Compilation module
321 Performance analysis unit
322 Single-node optimization unit
323 Collaborated optimization unit
S11˜S14 Steps S11-S14

### DETAILED DESCRIPTION OF THE INVENTION

Embodiments of the present disclosure will be described below. Those skilled can easily understand advantages and effects of the present disclosure according to contents disclosed by the specification. The present disclosure can also be implemented or applied through other different exemplary embodiments. Various modifications or changes can also be made to all details in the specification based on different points of view and applications without departing from the spirit of the present disclosure. It should be noted that the following embodiments and the features of the following embodiments can be combined with each other if no conflict will result.

It should be noted that the drawings provided in this disclosure only illustrate the basic concept of the present disclosure in a schematic way, so the drawings only show the components closely related to the present disclosure. The drawings are not necessarily drawn according to the number, shape and size of the components in actual implementation; during the actual implementation, the type, quantity and proportion of each component can be changed as needed, and the components' layout may also be more complicated.

### Embodiment 1

Embodiment 1 provides a method for compiling a neural network, comprising:
translating a network file into an intermediate representation file;
optimizing the intermediate representation file to obtain an optimized intermediate representation file, based on a performance analysis, single-node optimization, and collaborated optimization;
generating a network template file based on hardware interfaces through the optimized intermediate representation file;
compiling the network template file into an executable inference application.

The method for compiling the neural network will be described in detail below with reference to the drawings. The method for compiling the neural network in Embodiment 1 provides users with an end-to-end inference service. It involves generating the network template file based on target hardware interfaces through existing and pre-packaged network files, and then the executable inference application is created. This optimization process further enhances the execution efficiency for code generation.

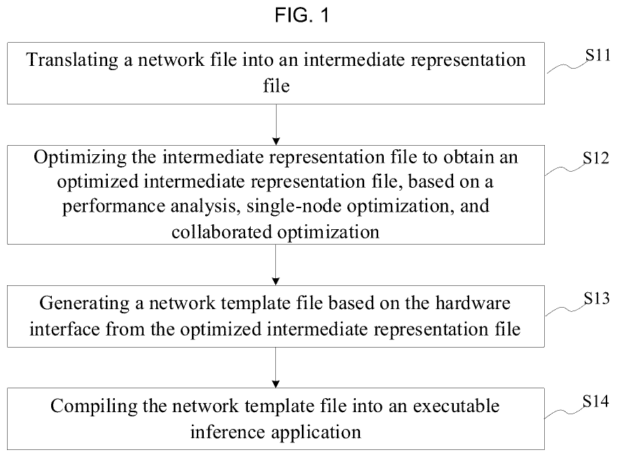

FIG. 1 shows a flowchart of the method for compiling the neural network according to Embodiment 1. As shown in FIG. 1, the method for compiling the neural network specific comprises steps S11-S14.

S11: translating a network file into an intermediate representation file.

S11 specifically involves using application programming interfaces (APIs) in the Python. ONNX Library to read an ONNX-formatted neural network file into structured data. The structured data comprises information such as network structure (computation graph), operator details (nodes of the computation graph), etc. Additionally, the necessary weight information for the operators contained in the ONNX-formatted neural network file is extracted by using tensor virtual machine (TVM), and is stored as a text file for later use.

Specifically, the network file (or, neural network file) comprises the network structure and network parameters, and is translated into the intermediate representation file, which contains part of hardware information.

In Embodiment 1, the intermediate representation file comprises an abstraction layer, descriptions of the abstraction layer, and primary domains of the abstraction layer.

The abstraction layer comprises a model, an operator set, fusion blocks, basic layers, and operational operators.

A description of the model comprises describing a complete model execution flow; a description of the operator set comprises specifying an operator set version; a description of the fusion blocks comprises comprising a block fused from basic layers; a description of the basic layers comprises representing one of the operational operators in the network file; and a description of the operational operators comprises providing a detailed description of the operational operators.
Primary domains of the model comprise a set of fusion blocks, and their intermediate representation;
Primary domains of the operator set comprise its version and a list of included operators;
Primary domains of the fusion blocks comprise a set of layers, and inputs and outputs of the layers;
Primary domains of the basic layers comprise operational operators, inputs, outputs, and model parallelisms; and
Primary domains of the operational operators comprise operator types and operator attributes.

The specific contents of the intermediate representation file are shown in Table 1.

TABLE 1
Specific Contents of The Intermediate Representation File

| Abstraction | | |
|---|---|---|
| layers | Descriptions | Primary domains |
| Model | Describing a complete model | A set of fusion blocks, and their |
| | execution flow | intermediate representation |
| Operator set | Specifying an operator set version | Its version and a list of included |
| | | operators |
| Fusion blocks | Comprising a block fused from | A set of layers, and inputs and |
| | basic layers | outputs of the layers |
| Basic layers | Representing one of the | Operational operators, inputs, |
| | operational operators in the | outputs, and model |
| | network file | parallelisms |
| Operational | Providing a detailed description of | Operator types and operator |
| operators | the operational operators | attributes |

S12: optimizing the intermediate representation file to obtain an optimized intermediate representation file, based on a performance analysis, single-node optimization, and collaborated optimization.

Specifically, the optimizing of the intermediate representation file based on the performance analysis comprises:

portraying the performance of the operational operators through performance tests, generating a series of measured performances with varying parameters, obtaining influence parameters affecting the performance of the operational operators, and constructing a mathematical model by the influence parameters to portray the performance of the operational operators. In Embodiment 1, due to the significant difference of the performance of the operational operators between the actual network and the theoretical model during development, the intermediate representation file is optimized through the performance analysis.

To achieve this, the influence parameters affecting the performance of the operational operators are calculated using principal component analysis (PCA).

Taking Cambricon MLU-100 as an example, during convolution operations, a computational amount of the operational operators and the number of channels are main parameters that affect the performance of the operational operators.

The optimizing of the intermediate representation file based on the single-node optimization comprises:

Optimizing nodes to be optimized one by one or portraying performance variation thereof, based on optimization results obtained by optimizing the intermediate representation file through the performance analysis and the target hardware interfaces.

Taking Cambricon MLU-100 as an example, the optimizing of the intermediate representation file based on the single-node optimization comprises portraying the model parallelisms and operator fusion, selecting an optimal model parallelism for the operational operators, and portraying dimensions of fusion blocks, redundant computational amounts, and performance variation.

The optimizing of the intermediate representation file based on the collaborated optimization is as follows:

Given the multitude of the nodes to be optimized and the vast choices for each node, using a straightforward search approach is impractical. Instead, the heuristic information is incorporated into our search process. When using the heuristic information for search, it is essential to evaluate the quality of parameter choices. However, existing performance models for hardware often diverge significantly from the actual runtime behavior of operators, making it challenging to accurately portraying their performance. To address this issue, a set of operators with varying parameters is generated through the performance tests to measure the actual runtime behavior of operators. Subsequently, the PCA is applied to identify the most significant parameters affecting the performance of the operational operators, and these parameters are configured for constructing the mathematical model. For instance, when considering MLU-100, the PCA may reveal that the computational amount of the operational operators significantly impacts their performance. As a result, in subsequent single-node and collaborated optimization processes, constructing the mathematical model through the computational amount can be used as an optimization guide.

Interfaces provided by MLU-100 primarily focus on optimizing the model parallelism and fusion modes, thus the single-node optimization focuses on these two nodes to be optimized and portrays the performance variation.

a. Model Parallelism: MLU-100 features a multi-core architecture, allowing allocation of several cores per operator for calculating. However, allocating too many cores to one operator results in small per-core computational amount, preventing cores from reaching saturation and increasing inter-core communication overhead. Guided by the significant impact of computational amount on the performance of the operational operators, a relationship between the optimal model parallelism and the computational amount is constructed through performance tests, which in turn determines a model parallelism of the basic layers.

b. Operator Fusion: Fusing multiple operators into a single fused operator increases the model parallelism through pipelining. However, larger fusion blocks with higher model parallelism introduce more redundant computational amounts due to the halo effect in convolutional calculations. To address this, the dimensions of fusion blocks and the model parallelism need to be controlled. Research on fusion blocks with varying computational amounts reveals that when a computation-to-parallelization ratio approaches a per-core saturation computational amount, the fusion blocks balance performance gains from parallelization and overhead from redundancy.

During collaborated optimization, an optimal fusion mode is selected for the model, and each of the fusion blocks is configured with an optimal model parallelism. Since each fusion block can only be configured with a uniform model parallelism, and different layers within the fusion block may have varying optimal model parallelism, the method in Embodiment 1 aims to first determine the model parallelism for each layer and then aggregate layers with similar parallelism for fusion. During fusion, the dimensions of fusion blocks are controlled to ensure that a ratio of a total computational amount of fusion blocks to the model parallelism remains close to but below the per-core saturation computational amount.

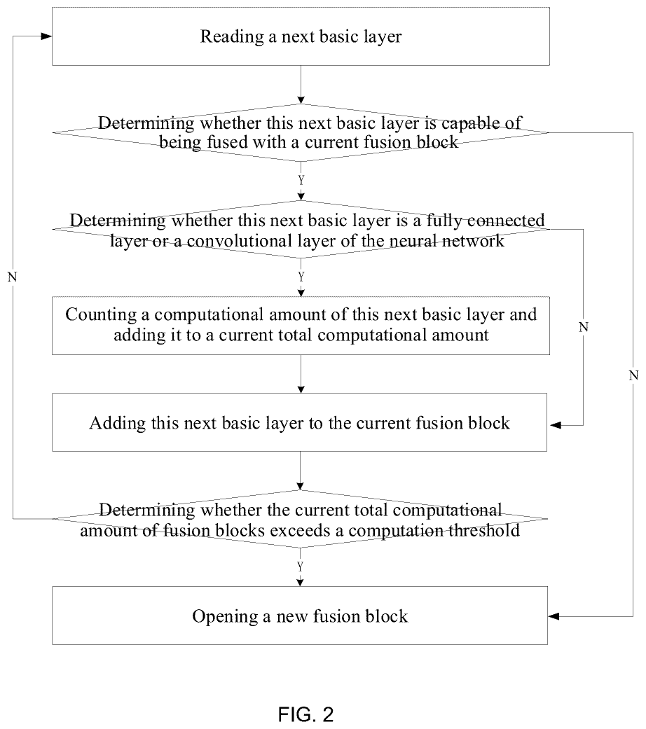

FIG. 2 shows a flowchart illustrating an optimization of the intermediate representation file based on the collaborated optimization according to Embodiment 1. As shown in FIG. 2, the optimizing of the intermediate representation file based on the collaborated optimization comprises steps S21-S27.
S21: reading a next basic layer;
S22: determining whether this next basic layer is capable of being fused with a current fusion block; if capable, then performing S23: determining whether this next basic layer is a fully connected layer or a convolutional layer of the neural network; if yes, performing S24: counting a computational amount of this next basic layer and adding it to a current total computational amount, and performing S25: adding this next basic layer to the current fusion block, and proceeding to S27; if no, directly performing S25: adding this next basic layer to the current fusion block and proceeding to S27; if not capable, performing S26: opening a new fusion block;
S27: determining whether the current total computational amount of fusion blocks exceeds a computation threshold, if yes, proceeding to S26; if no, returning to S21.

S13: generating a network template file based on the hardware interface from the optimized intermediate representation file.

S13 specifically involves traversing the intermediate representation file and processing it layer by layer. Each unit in the intermediate representation file contains information about individual operators (layers). Therefore, during traversal, a text file conforming to hardware interface syntax is generated based on the information of individual operators. This text file serves as the network template file within a software development toolkit.

In Embodiment 1, S13 further utilizes the abstraction layer to hide redundant operations (such as initialization and memory allocation) and expose the nodes to be optimized.

For example, S13 can list the interfaces provided by Cambricon MLU-100 and the nodes to be optimized supported by an intermediate layer.

In Embodiment 1, the network template file enables the user to easily adjust the network structure, hyperparameters, etc., and can support runtime adjustment of part of the hyperparameters.

S14: compiling the network template file into an executable inference application.

In Embodiment 1, the network template file is compiled into the executable inference application by a G++ compiler.

Embodiment 1 further provides a non-transitory computer-readable storage medium (also called computer readable storage medium) having stored thereon a computer program. When executed by a processor, the computer program implements the method for compiling the neural network.

Those of ordinary skill will understand that all or part of the steps to implement the various methods described above may be accomplished by hardware associated with computer programs. The aforementioned computer program may be stored in a computer readable storage medium. The program, when executed, performs the operations comprising the above method embodiments. The foregoing storage medium comprises various medium that may store program codes, such as a ROM, a RAM, a magnetic disk, or an optical disk.

The method for compiling the neural network aims to design and implement an automated compilation toolchain framework. This framework adjusts parameters, generates code, creates IRs, and applies optimization algorithms based on software and hardware information. When this compilation toolchain operates on a target chip, it ensures consistent network output results, achieves higher computation rates within shorter optimization times, reduces computation delays, and facilitates user debugging and tuning.

### Embodiment 2

Embodiment 2 provides a system 3 for compiling the neural network, comprising:
a translation module configured to translate a network file into an intermediate representation file;
an optimization module configured to optimize the intermediate representation file to obtain an optimized intermediate representation file, based on a performance analysis, single-node optimization, and collaborated optimization;
a file generation module configured to generate a network template file based on hardware interfaces through the optimized intermediate representation file; and
a compilation module configured to compile the network template file into an executable inference application.

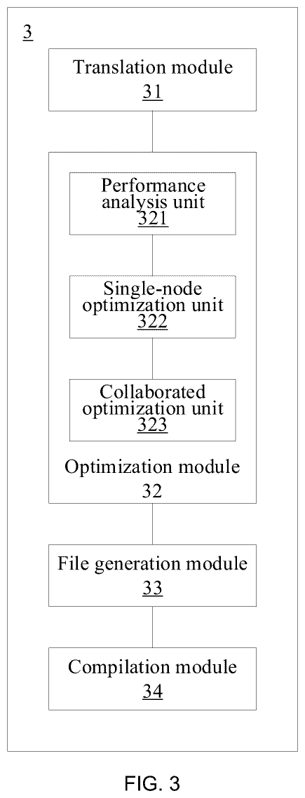

The system 3 provided in Embodiment 2 will be described in detail below in conjunction with the drawings. FIG. 3 shows a schematic diagram of the system 3. As shown in FIG. 3, the system 3 comprises a translation module 31, an optimization module 32, a file generation module 33, and a compilation module 34.

The translation module 31 is configured to translate a network file into an intermediate representation file.

Specifically, the translation module 31 translates the network file consisting of network structure and network parameters into the intermediate representation file, which contains part of hardware information.

More specifically, the translation module 31 uses APIs in the Python. ONNX Library to read an ONNX-formatted neural network file into structured data. The structured data comprises information such as network structure (computation graph), operator details (nodes of the computation graph), etc. Additionally, the necessary weight information for the operators contained in the ONNX-formatted neural network file is extracted by using TVM, and is stored as a text file for later use.

In Embodiment 2, the intermediate representation file comprises an abstraction layer, descriptions of the abstraction layer, and primary domains of the abstraction layer.

The abstraction layer comprises a model, an operator set, fusion blocks, basic layers, and operational operators.

A description of the model comprises describing a complete model execution flow; a description of the operator set comprises specifying an operator set version; a description of the fusion blocks comprises comprising a block fused from basic layers; a description of the basic layers comprises representing one of the operational operators in the network file; and a description of the operational operators comprises providing a detailed description of the operational operators.
Primary domains of the model comprise a set of fusion blocks, and their intermediate representation;
Primary domains of the operator set comprise its version and a list of included operators;
Primary domains of the fusion blocks comprise a set of layers, and inputs and outputs of the layers;
Primary domains of the basic layers comprise operational operators, inputs, outputs, and model parallelisms; and
Primary domains of the operational operators comprise operator types and operator attributes.

The optimization module 32 is configured to optimize the intermediate representation file to obtain an optimized intermediate representation file, based on a performance analysis, single-node optimization, and collaborated optimization. Continuing to refer to FIG. 3, the optimization module 32 comprises a performance analysis unit 321, a single-node optimization unit 322 and a collaborated optimization unit 323.

The performance analysis unit 321 is configured to optimize the intermediate representation file based on the performance analysis.

Specifically, the performance analysis unit 321 portrays the performance of the operational operators through performance tests, generates a series of measured performances with varying parameters, obtains influence parameters affecting the performance of the operational operators, and constructs a mathematical model by the influence parameters to portray the performance of the operational operators. In Embodiment 2, due to the significant difference of the performance of the operational operators between the actual network and the theoretical model during development, the intermediate representation file is optimized through the performance analysis.

To achieve this, the influence parameters affecting the performance of the operational operators are calculated using PCA.

The single-node optimization unit 322 is configured to optimize the intermediate representation file based on the single-node optimization.

Specifically, the single-node optimization unit 322 optimizes the nodes to be optimized one by one or portrays performance variation, based on optimization results obtained by optimizing the intermediate representation file through the performance analysis and the target hardware interfaces.

The collaborated optimization unit 323 is configured to optimize the intermediate representation file based on the collaborated optimization.

Specifically, the collaborated optimization unit 323 is configured to perform the steps S21-S27. S21: reading a next basic layer; S22: determining whether this next basic layer is capable of being fused with a current fusion block; if capable, then performing S23: determining whether this next basic layer is a fully connected layer or a convolutional layer of the neural network; if yes, performing S24: counting a computational amount of this next basic layer and adding it to a current total computational amount, and performing S25: adding this next basic layer to the current fusion block, and proceeding to S27; if no, directly performing S25: adding this next basic layer to the current fusion block and proceeding to S27; if not capable, performing S26: opening a new fusion block; S27: determining whether the current total computational amount of fusion blocks exceeds a computation threshold, if yes, proceeding to S26; if no, returning to S21.

The file generation module 33 is configured to generate a network template file based on hardware interfaces through the optimized intermediate representation file. The network template file is a file within a software development toolkit.

Specifically, the file generation module 33 traverses the intermediate representation file and processing it layer by layer. Each unit in the intermediate representation file contains information about individual operators (layers). During traversal, a text file conforming to hardware interface syntax is generated based on the information of individual operators. This text file serves as the network template file within a software development toolkit.

In Embodiment 2, the file generation module 33 further utilizes the abstraction layer to hide redundant operations (such as initialization and memory allocation) and expose the nodes to be optimized.

In Embodiment 2, the network template file enables the user to easily adjust the network structure, hyperparameters, etc., and can support runtime adjustment of part of the hyperparameters.

The compilation module 34 is configured to compile the network template file into an executable inference application.

In Embodiment 2, the compilation module 34 compiles the network template file into the executable inference application by a G++ compiler.

It needs to be noted that it should be understood that the division of modules of the above device is only a logical function division, and the modules can be fully or partially integrated into a physical entity or physically separated in the actual implementation. In one embodiment, these modules can all be implemented in the form of software called by processing components. In one embodiment, they can also be all implemented in the form of hardware. In one embodiment, some of the modules can also be realized in the form of software called by processing components, and some of the modules can be realized in the form of hardware. For example, an x module may be a separate processing component, or may be integrated in a chip of the above-mentioned system. In addition, the x module may also be stored in the memory of the above system in the form of program code. The function of the above x module is called and executed by a processing component of the above system. The implementation of other modules is similar. All or part of these modules may be integrated or implemented independently. The processing elements described herein may be an integrated circuit with signal processing capabilities. In the implementation process, each operation of the above method or each of the above modules may be completed by an integrated logic circuit of hardware in the processor element or an instruction in a form of software. The above modules may be one or more integrated circuits configured to implement the above method, such as one or more Application Specific Integrated Circuits (ASICs), one or more Digital Signal Processors (DSPs), or one or more Field Programmable Gate Arrays (FPGAs). When one of the above modules is implemented in the form of calling program codes by a processing component, the processing component may be a general processor, such as a Central Processing Unit (CPU) or other processors that may call program codes. These modules may be integrated and implemented in the form of a system-on-a-chip (SOC).

### Embodiment 3

Embodiment 3 provides a compilation device, comprising a processor, a memory, a transceiver, a communication interface or/and a system bus. The memory and the communication interface are connected with the processor and the transceiver through the system bus to complete mutual communication. The memory stores computer programs, the communication interface communicates with other devices, and the processor and the transceiver run computer programs to enable the compilation device to perform the method for compiling the neural network as described in Embodiment 1.

The system bus mentioned above may be a Peripheral Component Interconnect (PCI) bus or an Extended Industry Standard Architecture (EISA) bus, etc. The system bus can be divided into an address bus, a data bus, a control bus, etc. For convenience of representation, only one thick line is used in the figure, but it does not mean that there is only one bus or one type of bus. The communication interface is used to implement communication between the database access device and other devices (such as a client, a read-write library, and a read-only library). The memory may comprise Random Access Memory (RAM), or may also comprise non-volatile memory, such as at least one disk memory.

The above processor may be a general processor, comprising a Central Processing Unit (CPU), a Network Processor (NP), and the like. It may also be a Digital Signal Processor (DSP), an Application Specific Integrated Circuit (ASIC), a Field-Programmable Gate Array (FPGA), or other programmable logic devices, discrete gate or transistor logic devices, or discrete hardware components.

The protection scope of the method for compiling the neural network as described in the present disclosure is not limited to the sequence of steps listed in this embodiment. Any scheme realized by adding or subtracting steps or replacing steps of the existing techniques according to the principle of the present disclosure is comprised in the protection scope of the present disclosure.

The present disclosure further provides the system for compiling the neural network, this system can implement the method described in Embodiment 1, but the device for implementing the method described in Embodiment 1 comprises, but is not limited to, the system as described in Embodiment 2. Any structural adjustment or replacement of the prior art made according to the principles of the present disclosure is comprised in the scope of the present disclosure.

In summary, the method and system for compiling the neural network, the computer storage medium, and the compilation device of the present disclosure aim to design and implement an automated compilation toolchain framework. This framework adjusts parameters, generates code, creates IRs, and applies optimization algorithms based on software and hardware information. When this compilation toolchain operates on a target chip, it ensures consistent network output results higher computation rates within shorter optimization times, reduces computation delays, and facilitates user debugging and tuning. The present disclosure effectively overcomes various shortcomings and a has high industrial value.

The above-mentioned embodiments are merely illustrative of the principle and effects of the present disclosure instead of restricting the scope of the present disclosure. Any person skilled in the art may modify or change the above embodiments without violating the principle of the present disclosure. Therefore, all equivalent modifications or changes made by those who have common knowledge in the art without departing from the spirit and technical concept disclosed by the present disclosure shall be still covered by the claims of the present disclosure.

1. A method for compiling a neural network, comprising:
translating a network file into an intermediate representation file;
optimizing the intermediate representation file to obtain an optimized intermediate representation file, based on a performance analysis, single-node optimization, and collaborated optimization;
generating a network template file based on hardware interfaces through the optimized intermediate representation file;
compiling the network template file into an executable inference application.

2. The method for compiling the neural network according to claim 1, wherein
the network file comprises a network structure and network parameters;
the intermediate representation file comprises an abstraction layer, descriptions of the abstraction layer, and primary domains of the abstraction layer;
the abstraction layer comprises a model, an operator set, fusion blocks, basic layers, and operational operators;
a description of the model comprises describing a complete model execution flow; a description of the operator set comprises specifying an operator set version; a description of the fusion blocks comprises comprising a block fused from basic layers; a description of the basic layers comprises representing one of the operational operators in the network file; a description of the operational operators comprises providing a detailed description of the operational operators;
primary domains of the model comprise a set of fusion blocks, and their intermediate representation;
primary domains of the operator set comprise its version and a list of included operators;
primary domains of the fusion blocks comprise a set of layers, and inputs and outputs of the layers;
primary domains of the basic layers comprise operational operators, inputs, outputs, and model parallelisms;
primary domains of the operational operator comprise operator types and operator attributes.

3. The method for compiling the neural network according to claim 2, wherein the optimizing of the intermediate representation file based on the performance analysis comprises:
portraying the performance of the operational operators through performance tests, generating a series of measured performances with varying parameters, obtaining influence parameters affecting the performance of the operational operators, and constructing a mathematical model by the influence parameters to portray the performance of the operational operators.

4. The method for compiling the neural network according to claim 3, wherein the optimizing of the intermediate representation file based on the single-node optimization comprises:
portraying the model parallelisms and operator fusion, selecting an optimal model parallelism for the operational operators, and portraying dimensions of fusion blocks, redundant computational amounts, and performance variation.

5. The method for compiling the neural network according to claim 3, wherein the optimizing of the intermediate representation file based on the collaborated optimization comprises:
S21: reading a next basic layer;
S22: determining whether this next basic layer is capable of being fused with a current fusion block;
if capable, then performing S23: determining whether this next basic layer is a fully connected layer or a convolutional layer of the neural network;
if yes, performing S24: counting a computational amount of this next basic layer and adding it to a current total computational amount, and performing S25: adding this next basic layer to the current fusion block, and proceeding to S27;
if no, directly performing S25: adding this next basic layer to the current fusion block and proceeding to S27;
if not capable, performing S26: opening a new fusion block;
S27: determining whether the current total computational amount of fusion blocks exceeds a computation threshold, if yes, proceeding to S26; if no, returning to S21.

6. The method for compiling the neural network according to claim 3, wherein the generating of the network template file further comprises hiding redundant operations and exposing nodes to be optimized, by the abstraction layer.

7. The method for compiling the neural network according to claim 3, wherein the network template file is compiled into the executable inference application by a G++ compiler.

8. A system for compiling a neural network, comprising:
a translation module configured to translate a network file into an intermediate representation file;
an optimization module configured to optimize the intermediate representation file to obtain an optimized intermediate representation file, based on a performance analysis, single-node optimization, and collaborated optimization;
a file generation module configured to generate a network template file based on hardware interfaces through the optimized intermediate representation file; and
a compilation module configured to compile the network template file into an executable inference application.

9. A non-transitory computer-readable storage medium, configured to store a computer program, wherein the method for compiling the neural network according to claim 1 is implemented when the computer program is executed by a processor.

10. A compilation device, comprising a processor and a memory;
wherein the memory is configured to store a computer program, and the processor is configured to execute the computer program stored in the memory, such that the compilation device implements the method for compiling the neural network according to claim 1.
